(19) United States
(12) Patent Application Publication
(10) Pub. No.: US 2024/0018949 A1
(43) Pub. Date: Jan. 18, 2024

(54) GRAVITATIONAL POTENTIAL ENERGY CONVERTING DEVICE FOR VEHICLE

(71) Applicants: Tuen-Keui TSAI, Hualien County (TW); Mei-Hui WANG, Hualien County (TW); Cian-Kuan CAI, Hualien County (TW)

(72) Inventors: Tuen-Keui TSAI, Hualien County (TW); Mei-Hui WANG, Hualien County (TW); Cian-Kuan CAI, Hualien County (TW)

(21) Appl. No.: 17/865,434

(22) Filed: Jul. 15, 2022

(51) Int. Cl. F03G 7/08

(52) U.S. Cl. CPC F03G 7/081; B29D 2030/0094

(57) ABSTRACT

A gravitational energy conversion device for a vehicle has a rotating part and multiple energy converters. The rotating part is rotatably mounted between a vehicle main body and the ground; the energy converters are mounted on an outer annular surface of the rotating part and are disposed apart from each other around the rotating part. Each energy converter has a moving part and a resilient part. The moving part protrudes from the outer annular surface of the rotating part, and is movable toward or away from the rotating part. The resilient part is mounted between the moving part and the rotating part, and drives the moving part to move away from the rotating part. When the rotating part rotates to a specific angle, weight of the vehicle main body presses down the energy converter to move the moving part toward the rotating part, thereby increasing elastic energy stored in the resilient part; when the rotating part rotates away from the specific angle, the resilient part drives the moving part away from the rotating part, thereby converting the elastic energy stored in the resilient part to kinetic energy of the vehicle main body.

### BACKGROUND OF THE INVENTION

### 1. Field of the Invention

The present creation relates to a transportation tool, especially to a vehicle.

### 2. Description of the Prior Arts

A conventional vehicle bounces up and down when driven on a bumpy road; however, it is a pity that kinetic energy associated with the bouncing is converted into thermal energy by a suspension system, and therefore cannot be recycled. As a result, the conventional vehicle needs to be improved.

### SUMMARY OF THE INVENTION

In view of the drawbacks and deficiencies of the aforementioned prior art, a gravitational energy conversion device for a vehicle is provided in the present creation to recycle kinetic energy associated with the vehicle bouncing up and down.

To achieve the above mentioned purpose of creation, the technical means employed by the present creation is to design a gravitational energy conversion device for a vehicle, comprising a rotating part and multiple energy converters. The rotating part is rotatably mounted between a vehicle main body and the ground. The energy converters are mounted on an outer annular surface of the rotating part and are disposed apart from each other around the rotating part. Each energy converter has a moving part and a resilient part; the moving part protrudes from the outer annular surface of the rotating part, and is movable toward or away from the rotating part. The resilient part is mounted between the moving part and the rotating part, and drives the moving part to move away from the rotating part. When the rotating part rotates to a specific angle, weight of the vehicle main body presses down the energy converter to move the moving part toward the rotating part, thereby increasing elastic energy stored in the resilient part. When the rotating part rotates away from the specific angle, the resilient part drives the moving part away from the rotating part, thereby converting the elastic energy stored in the resilient part to kinetic energy of the vehicle main body.

To achieve the above mentioned purpose of creation, the present creation further provides a gravitational energy conversion device for a vehicle, comprising a main body, a caterpillar band, and multiple energy converters. The main body is disposed between a vehicle main body and the ground. The caterpillar band is located around the main body, and is capable of revolving around the main body. The caterpillar band is configured to drive the vehicle main body to translate on the ground. The energy converters are disposed apart from each other on the caterpillar band. Each of the energy converters has a moving part and a resilient part. The moving part protrudes from an outer surface of the caterpillar band, and is movable toward or away from the rotating part. The resilient part is mounted between the moving part and the caterpillar band, and drives the moving part to move away from the rotating part. When the caterpillar band moves to make the energy converter contact the ground, weight of the vehicle main body presses down the energy converter to move the moving part toward the rotating part, thereby increasing elastic energy stored in the resilient part. When the caterpillar band moves to separate the energy converter from the ground, the resilient part drives the moving part to move away from the rotating part, thereby converting the elastic energy stored in the resilient part to kinetic energy of the vehicle main body.

To achieve the above mentioned purpose of creation, the present creation further provides a gravitational energy conversion device for a vehicle, configured to rotate on a support surface; the gravitational energy conversion device comprises a rotating part and multiple energy converters. The rotating part is rotatably mounted between a vehicle main body and the ground. The energy converters are disposed around the rotating part. Each of the energy converters has a moving part and a linear electrical generator. The moving part protrudes from an outer surface of the rotating part, and is movable toward or away from the rotating part. Two ends of the linear electrical generator are mounted to the rotating part and the moving part of the energy converter respectively. When the moving part is moved, the linear electrical generator generates electricity. When the rotating part rotates to a specific angle, weight of the vehicle main body presses down the energy converter to move the moving part toward the rotating part, thereby making the linear electrical generator generate electricity. When the rotating part rotates away from the specific angle, centrifugal force due to rotation of the rotating part makes the moving part move away from the rotating part.

The advantage of the present creation is being able to recycle the kinetic energy associated with a vehicle bouncing up and down.

To take a step further, all movable objects are subjected to gravitational force during operation, meanwhile the movable objects are also subjected to reaction force of the gravitational force for certain. Newton's law: action force equals reaction force, and in this case, assuming reaction force of the gravitational force (gravity) becomes a driving force which drives a vehicle to move forward. MG=MA; then G=A. Moreover, the acceleration is fast enough and if 100% conversion can be achieved, a speed of the vehicle will exceed 100 KM/H within 2 seconds.

Assume a compact car has a power output of 140 PS, around 100 KW. It takes around 16570 KG-M/S of acceleration using mechanics, which is a very difficult task; it is more possible to achieve using electricity, and vehicles do not always operate at maximum power output. Assuming the power is generated by the reaction force of gravitational force during operation of the vehicle, for general motorbikes with powers around 8 KW, and for electric bicycles with powers even less than 1000 W, it is quite possible to achieve.

### BRIEF DESCRIPTION OF THE DRAWINGS

FIG. 1 is a schematic side view of a first embodiment in accordance with the present invention;

FIG. 2 is a schematic side view of a second embodiment in accordance with the present invention;

FIG. 3 is a schematic sectional view of an energy converter of a gravitational energy conversion device in FIG. 2;

FIG. 4 is a schematic side view of a third embodiment in accordance with the present invention;

FIG. 5 is a schematic sectional view of an energy converter of a gravitational energy conversion device in FIG. 4; and

FIG. 6 is a schematic side view of a fourth embodiment in accordance with the present invention.

### DETAILED DESCRIPTION OF THE PREFERRED EMBODIMENTS

Technical means employed by the present invention for achieving intended purpose of the invention are explained with drawings and preferred embodiments in accordance with the present invention.

Reaction force between a vehicle and the ground acts on tires for certain. Reaction force of gravitational force is directed upward, and how to change the direction of the reaction force? Then begin with mechanical force: mount one-directional curved flat springs, or use coil springs together with curved steel plates; the springs are pressed as the vehicle moves forward, and the springs bounce back after passing support point, and the bouncing force forces a wheel to rotate further. This method is effective when the vehicle moves forward, but is counterproductive when the vehicle moves backward, and what about power required for first start up? This method only saves energy, but still requires an engine, and mechanical contact means limited use life.

In the present invention, reaction force of the vehicle and the ground acts on tires for certain; soften the tires or reduce tire pressures such that the tires have deflections between 10-30 mm when rotated to be in contact with the ground. Rubber tires can be omitted as the present device may function as a shock-absorbing system. Mechanical type: constituted by mounting curved flat springs, or using coil springs together with curved steel plates. As the vehicle moves forward, the springs are compressed by gravity when in contact with the ground, and the springs bounce back after passing the support point with the ground; each of the bouncing forces equals two component forces: one component force cancels out the gravitational force, and the other component force forces the wheel to rotate further. MG=MA is an ideal but impossible condition, and a moving device has sufficient energy as long as A=G no matter how large the M is; 9.80665 m/s2 serves as extra driving force which drives the moving device to move forward regardless of conversion rates. A number of the flat springs or its coefficient of elasticity needs to be precisely calculated based on a weight of M, and spare wheels, which are only lowered when the vehicle is carrying loads, can also be adopted with a hope that more reaction force can be converted into the driving force.

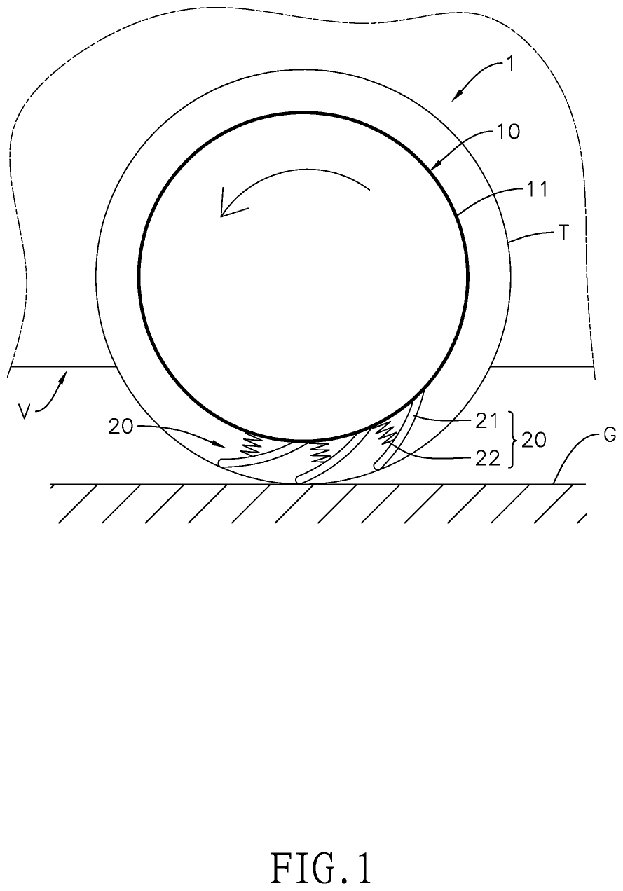

With reference to FIG. 1, a first embodiment of a gravitational energy conversion device for vehicle 1 in accordance with the present invention comprises a rotating part 10 and multiple energy converters 20. The rotating part 10 is cylindrical and rotatably mounted between a vehicle main body and the ground G. The rotating part 10 is preferably a rim, but may also be an axle shaft of the vehicle.

The energy converters 20 are mounted around an outer annular surface 11 of the rotating part 10 and disposed apart from each other. Each of the energy converters 20 has a moving part 21 and a resilient part 22. The moving part 21 protrudes from the outer annular surface 11 of the rotating part 10, and is movable toward or away from the rotating part 10. The moving part 21 is preferably a flat spring; an end of the moving part 21 is mounted to the rotating part 10, and another end of the moving part 21 protrudes from the outer annular surface 11 of the rotating part 10 and is movable toward or away from the rotating part 10. The resilient part 22 is mounted between the moving part 21 and the rotating part 10, and drives the moving part 21 to move away from the rotating part 10. In the preferred embodiment, a distal end of the moving part 21 abuts against an inner wall of the tire T.

When the rotating part 10 rotates to a specific angle (that is, when one of the energy converters 20 is at 6 o'clock position), weight of the vehicle main body V presses down the energy converter 20 to move the moving part 21 toward the rotating part 10, thereby increasing elastic energy stored in the resilient part 22. When the rotating part 10 rotates away from the specific angle, the resilient part 22 drives the moving part 21 away from the rotating part 10, thereby converting the elastic energy stored in the resilient part 22 to kinetic energy of the vehicle main body V.

In the preferred embodiment, each resilient part 22 is a helical spring (a.k.a. coil spring), but not limited thereto. Each resilient part 22 can be a gas spring or a magnetic spring as long as the resilient part 22 is capable of storing elastic energy. Moreover, when the moving part 21 itself is made of resilient materials and capable of storing elastic energy, the resilient part 22 can be omitted depending on the condition.

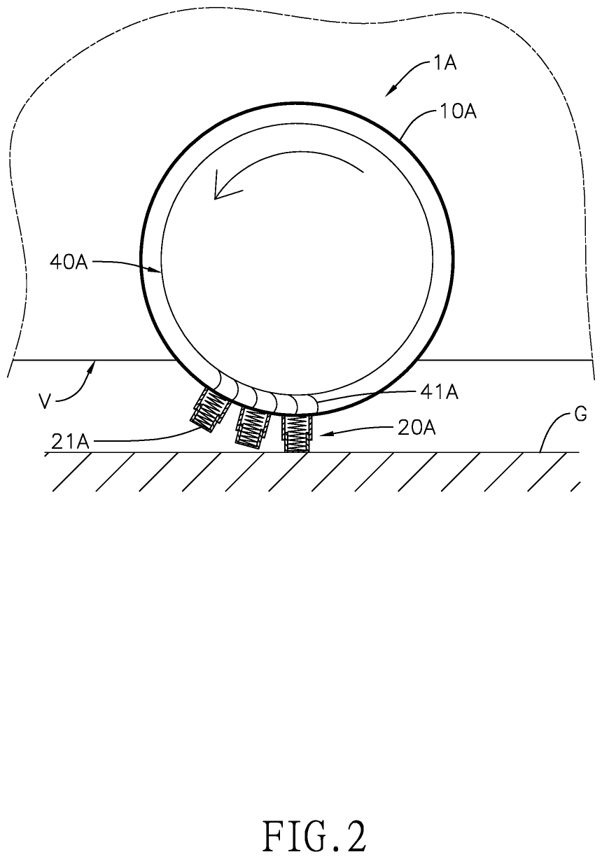

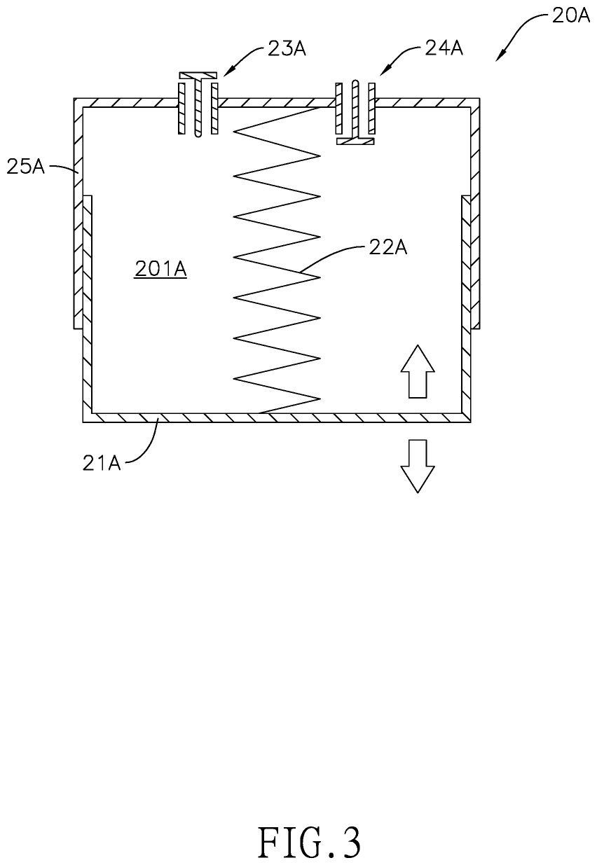

With reference to FIG. 2 and FIG. 3, a second embodiment of the gravitational energy conversion device lA in a second embodiment is substantially same as the first embodiment, but the difference is that the energy converters 20A in the second embodiment further comprise a fluid mechanism.

To be specific, the second embodiment further has a fluid actuator 40A in comparison with the first embodiment. The fluid actuator 40A is mounted between the vehicle main body V and the rotating part 10A. The fluid actuator 40A is preferably a turbine having multiple blades 41A.

Each of the energy converters 20A further has an output check valve 23A, an input check valve 24A, and a fixed part 25A. The fixed part 25A is fixed to the rotating part 10A, and the moving part 21A is movably connected to the fixed part 25A; a fluid chamber 201A is formed between the fixed part 25A and the moving part 21A; two ends of the output check valve 23A are connected to the fluid chamber 201A and the fluid actuator 40A respectively; two ends of the input check valve 24A are connected to the fluid chamber 201A and the fluid actuator 40A respectively.

When the energy converter 20A is pressed down by weight of the rotating part 10A and makes the moving part 21A move toward the rotating part 10A, the moving part 21A drives fluid in the fluid chamber 201A to flow into the fluid actuator 40A via the output check valve 23A; kinetic energy of said fluid is transferred to the fluid actuator 40A (turbine) via the blades 41A, and therefore makes the fluid actuator 40A drive the rotating part 10A to rotate. When the moving part 21A moves away from the rotating part 10A, the moving part 21A drives fluid in the fluid actuator 40A to flow into the fluid chamber 201A via the input check valve 24A. The fluid can be gas or liquid, but gas is compressible and therefore more difficult to use, and liquid is mainly used.

In another preferred embodiment (not shown in figures), the energy converter 20A is hidden inside the rotating part 10A, and only the moving part 21A protrudes from the rotating part 10A such that operating distance is fixed by an external frame of the rotating part 10A to reduce stress in the outer casing, and the rubber tires can be omitted and use the energy converter 20A for shock-absorbing.

In other words, the second embodiment is equivalent to mounting reciprocating pumps around a periphery of the rim of the vehicle, and each pump has a one-way valve mounted on each entrance and exit of said pump such that the entrance allows only entrance but not exit and that the exit allows only exit but not entrance. Utilizing pneumatic/hydraulic pressure to transfer power makes redirection of the reaction force of gravitational force easier. When the tire rotates, use the gravitational force to force the liquid in the pump to rush out, and then the liquid is guided into the turbine to push the wheel to rotate. When the gravitational force is moved away, use the springs to bounce back, and use vacuum suction force at this moment to replenish gas or liquid for the next rush-out. In this way, pressure is built up every time the pump contacts the ground due to rotation, and each pump repeatedly operates to transfer power to make the wheel rotate. It is better to have more frequent pressure built up due to gravity within a same amount of time, and this is how pneumatic/hydraulic pressures are used for redirecting the reaction force of gravitational force.

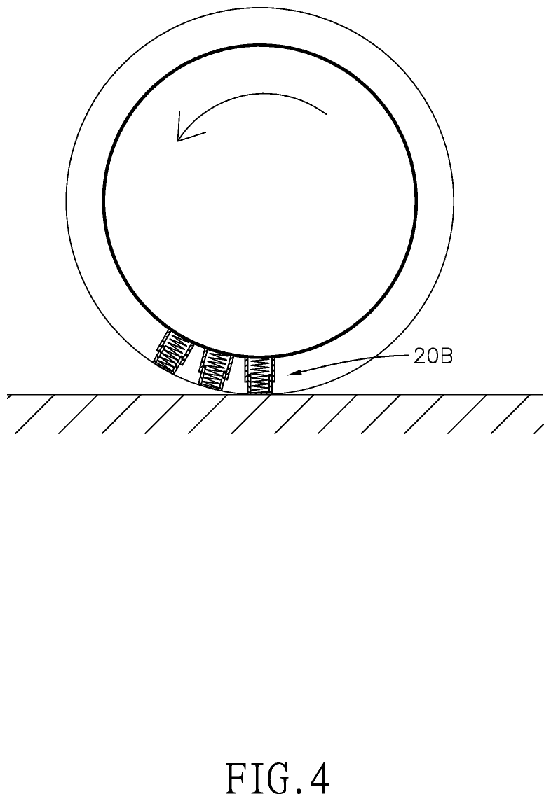

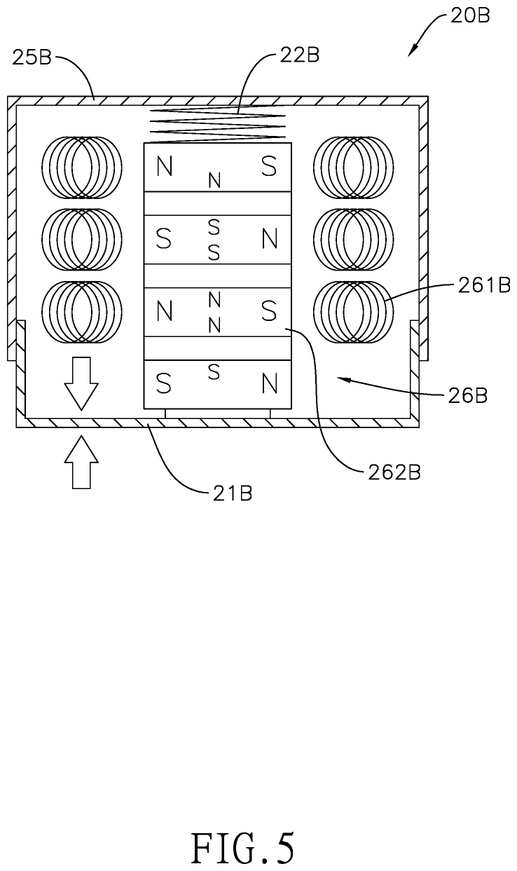

With reference to FIG. 4 and FIG. 5, a third embodiment of the energy converter 20B further has a linear electrical generator 26B mounted therein; principle of the linear electrical generator 26B is the same as that of traditional rotary electrical generators, and only replaces rotary motion with reciprocating motion. The linear electrical generator 26B has generating coils 261B and permanent magnets 262B; the generating coils 261B are mounted to the fixed part 25B, and the permanent magnets 262B are mounted to the moving part 21B. When the moving part 21B moves, the permanent magnets 262B move relative to the generating coil 261B such that the linear electrical generator 26B generates electricity. As a result, when the rotating part rotates to a specific angle, weight of the vehicle main body presses down the energy converter 20B and makes the moving part 21B move toward the rotating part, thereby making the linear electrical generator 26B generate electricity. The linear electrical generator 26B can be replaced by a piezoelectric device or a piezoelectric element depending on the condition.

In another embodiment having the linear electrical generator 26B, the resilient part 22B can be omitted; instead, when the rotating part rotates away from the specific angle, centrifugal force resulting from rotation of the rotating part makes the moving part 21B move away from the rotating part.

In other words, the third embodiment is mainly about installing linear electrical generators which are sealed on one side. When touching the ground, the linear electrical generators are compressed by reaction force of the gravitational force, and then bounce back the moving part using internal spring, reverse magnetic force, or sealed compressor; centrifugal force resulting from rotation of the tires can also be used for throwing out the moving part. The electricity generated by the linear electrical generators provides driving force for moving the device, and electric power is generated in each reciprocate stroke. It is better to have more of the linear electrical generators mounted in each tire, and each linear electrical generator generates electricity once every time the tire turns a full circle. It is also important to mount proper rigid body between the rim and the tire to limit maximum travel of the linear electrical generators and to protect the linear electrical generators.

The linear electrical generators are mounted on any position of the vehicle as long as said position is subjected to reaction force of gravitational force. The linear electrical generators are used for reciprocating motion for certain, and are primarily mounted between the rim and the tire; suspension system of the vehicle is the secondary position for mounting the linear electrical generators. When in motion (in contact with the ground), press it down using the reaction force of gravitational force, and mount internal springs, magnets, or sealed compressor on the other side for bouncing back the moving part respectively with the internal springs, reversed magnetic force, or pressure from compression; as a result, electric power is generated in each reciprocate stroke. It is better to have more of the linear electrical generators mounted in each tire, and each linear electrical generator generates electricity once every time the tire turns a full circle. Centrifugal force can also be used for throwing out the moving part. The electricity generated by the linear electrical generators provides the driving force for moving the device.

The linear electrical generators can be mounted on the suspension system of the vehicle. For example, coil springs, shock absorbers, and lower A-arms in a conventional vehicle can be replaced with numerous of the linear electrical generators. These positions of the vehicle are subjected to the reaction force of the gravitational force, and one should take advantage of it. In summary, all positions, which are subjected to the reaction force of the gravitational force during operation, on a moving device should be utilized in order to maximize conversion effect of the reaction force of gravitational force.

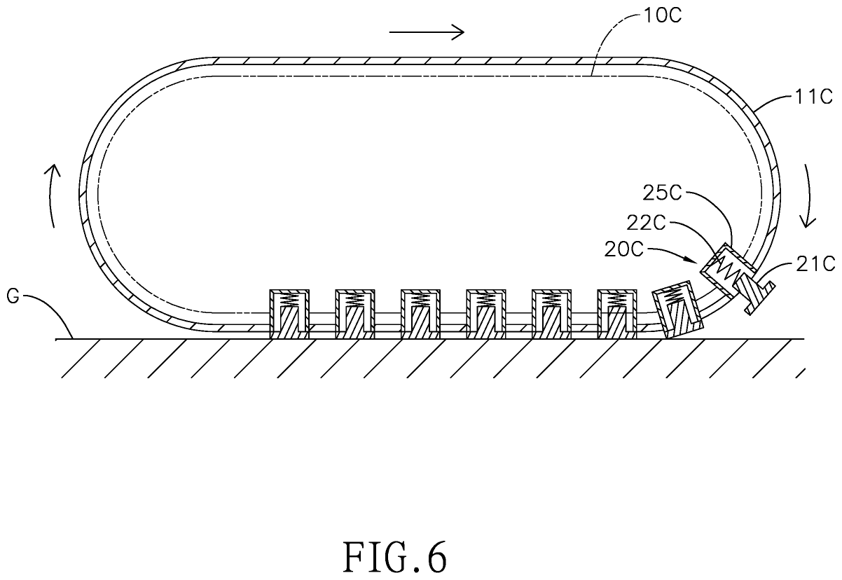

With reference to FIG. 6, a fourth embodiment of the gravitational energy conversion device differs from the first embodiment in that the rotating part 10C itself does not rotate, but instead a caterpillar band 11B is located around the rotating part 10C and enables the rotating part 10C to move on the ground G.

To be specific, the caterpillar band 11C is located around the rotating part 10C and is configured to revolving around the rotating part 10C. The caterpillar band 11C is configured to move the rotating part 10C on the ground G.

The energy converters 20C are disposed apart from each other on the caterpillar band 11C; the moving part 21C of each of the energy converters 20C protrudes from an outer surface of the caterpillar band 11C, and is movable toward or away from the rotating part 10C. The resilient part 22C is mounted between the moving part 21B and the caterpillar band 11C, and drives the moving part 21C away from the rotating part 10C. To be precise, a fixed part 25C of the energy converter 20C is mounted in the caterpillar band 11C; one end of the resilient part 22C abuts against the moving part 21C, and another end of the resilient part 22C abuts against the fixed part 25C such that the resilient part 22C is mounted between the caterpillar band 11C and the moving part 21C. The energy converter 20C is preferably retracted in the caterpillar band 11C (that is, the fixed part 25C is retracted in the caterpillar band 11C), and only the moving part 21C, which moves in a reciprocating manner, protrudes from the caterpillar band; as a result, the operating distance is fixed by an external frame of the caterpillar band 11C to reduce the stress in the outer casing.

When the caterpillar band 11C revolves around the rotating part 10C to make the energy converters 20C contact the ground G, weight of the rotating part 10C presses down the energy converters 20C to move the moving parts 21B toward the rotating part 10C, thereby increasing elastic energy stored in the resilient parts 22C. When the caterpillar band 11C moves to make the energy converters 20C separate from the ground G, the resilient parts 22C drive the moving parts 21B to move away from the rotating part 10C, thereby converting the elastic energy stored in the resilient parts 22C to kinetic energy of the rotating part 10C.

What is claimed is:

1. A gravitational energy conversion device for a vehicle, comprising:
a rotating part rotatably mounted between a vehicle main body and the ground;
multiple energy converters mounted on an outer annular surface of the rotating part and disposed apart from each other around the rotating part; each of the energy converters having
a moving part protruding from the outer annular surface of the rotating part, and being movable toward or away from the rotating part;
a resilient part mounted between the moving part and the rotating part, and driving the moving part to move away from the rotating part;
wherein, when the rotating part rotates to a specific angle, weight of the vehicle main body presses down the energy converter to move the moving part toward the rotating part, thereby increasing elastic energy stored in the resilient part;
wherein, when the rotating part rotates away from the specific angle, the resilient part drives the moving part away from the rotating part, thereby converting the elastic energy stored in the resilient part to kinetic energy of the vehicle main body.

2. The gravitational energy conversion device for a vehicle as claimed in claim 1, wherein the moving part of each of the energy converters is a flat spring; an end of said moving part is mounted to the rotating part; another end of the moving part protrudes from the outer annular surface of the rotating part and is movable toward or away from the rotating part.

3. The gravitational energy conversion device for a vehicle as claimed in claim 2, wherein the resilient part of each one of the energy converters is a helical spring, a gas spring, or a magnetic spring.

4. The gravitational energy conversion device for a vehicle as claimed in claim 1, wherein
the gravitational energy conversion device has a fluid actuator mounted between the vehicle main body and the rotating part;
each of the energy converters has a fluid chamber, having
an output check valve; two ends of the output check valve connected to the fluid chamber and the fluid actuator respectively;
an input check valve; two ends of the input check valve connected to the fluid chamber and the fluid actuator respectively;
wherein, when the energy converter is pressed down by the weight of the vehicle main body and makes the moving part move toward the rotating part, the moving part drives fluid in the fluid chamber to flow into the fluid actuator via the output check valve, and therefore makes the fluid actuator drive the rotating part to rotate;
when the moving part moves away from the rotating part, the moving part drives fluid in the fluid actuator to flow into the fluid chamber via the input check valve.

5. The gravitational energy conversion device for a vehicle as claimed in claim 3, wherein
the gravitational energy conversion device has a fluid actuator mounted between the vehicle main body and the rotating part;
each of the energy converters has a fluid chamber, having
an output check valve; two ends of the output check valve connected to the fluid chamber and the fluid actuator respectively;
an input check valve; two ends of the input check valve connected to the fluid chamber and the fluid actuator respectively;
wherein, when the energy converter is pressed down by the weight of the vehicle main body and makes the moving part move toward the rotating part, the moving part drives fluid in the fluid chamber to flow into the fluid actuator via the output check valve, and therefore makes the fluid actuator drive the rotating part to rotate;
when the moving part moves away from the rotating part, the moving part drives fluid in the fluid actuator to flow into the fluid chamber via the input check valve.

6. The gravitational energy conversion device for a vehicle as claimed in claim 1, wherein each of the energy converters has a linear electrical generator mounted in said energy converter; two ends of the linear electrical generator are mounted to the rotating part and the moving part respectively; when the moving part is moved, the linear electrical generator generates electricity.

7. The gravitational energy conversion device for a vehicle as claimed in claim 3, wherein each of the energy converters has a linear electrical generator mounted in said energy converter; two ends of the linear electrical generator are mounted to the rotating part and the moving part respectively; when the moving part is moved, the linear electrical generator generates electricity.

8. The gravitational energy conversion device for a vehicle as claimed in claim 1, wherein each of the energy converters has a piezoelectric device or a piezoelectric element mounted in said energy converter; when the moving part is moved, the piezoelectric device or the piezoelectric element generates electricity.

9. The gravitational energy conversion device for a vehicle as claimed in claim 3, wherein each of the energy converters has a piezoelectric device or a piezoelectric element mounted in said energy converter; when the moving part is moved, the piezoelectric device or the piezoelectric element generates electricity.

10. The gravitational energy conversion device for a vehicle as claimed in claim 1, wherein the rotating part is a rim or an axle shaft.

11. The gravitational energy conversion device for a vehicle as claimed in claim 5, wherein the rotating part is a rim or an axle shaft.

12. The gravitational energy conversion device for a vehicle as claimed in claim 7, wherein the rotating part is a rim or an axle shaft.

13. The gravitational energy conversion device for a vehicle as claimed in claim 9, wherein the rotating part is a rim or an axle shaft.

14. A gravitational energy conversion device for a vehicle, comprising:
a main body disposed between a vehicle main body and the ground;
a caterpillar band located around the main body, and being capable of revolving around the main body; the caterpillar band configured to drive the vehicle main body to translate on the ground;
multiple energy converters disposed apart from each other on the caterpillar band; each of the energy converters having
a moving part protruding from an outer surface of the caterpillar band, and being movable toward or away from the rotating part;
a resilient part mounted between the moving part and the caterpillar band, and driving the moving part to move away from the rotating part;
wherein, when the caterpillar band moves to make the energy converter contact the ground, weight of the vehicle main body presses down the energy converter to move the moving part toward the rotating part, thereby increasing elastic energy stored in the resilient part;
wherein, when the caterpillar band moves to separate the energy converter from the ground, the resilient part drives the moving part to move away from the rotating part, thereby converting the elastic energy stored in the resilient part to kinetic energy of the vehicle main body.

15. The gravitational energy conversion device for a vehicle as claimed in claim 14, wherein each of the energy converters has a fixed part retracted in the caterpillar band and movably connected to the corresponding moving part.

16. A gravitational energy conversion device for a vehicle, configured to rotate on a support surface, the gravitational energy conversion device comprising:
a rotating part rotatably mounted between a vehicle main body and the ground;
multiple energy converters disposed around the rotating part; each of the energy converters having
a moving part protruding from an outer surface of the rotating part, and being movable toward or away from the rotating part;
a linear electrical generator; two ends of the linear electrical generator are mounted to the rotating part and the moving part of the energy converter respectively; when the moving part is moved, the linear electrical generator generating electricity;
wherein, when the rotating part rotates to a specific angle, weight of the vehicle main body presses down the energy converter to move the moving part toward the rotating part, thereby making the linear electrical generator generate electricity;
wherein, when the rotating part rotates away from the specific angle, centrifugal force due to rotation of the rotating part makes the moving part move away from the rotating part.
